(19) United States
(12) Patent Application Publication
(10) Pub. No.: US 2004/0204177 A1
(43) Pub. Date: Oct. 14, 2004

(54) Mobile phone charger

(75) Inventor: Frankie Pon, (US)

Correspondence Address: Troxell Law Office PLLC, Suite 1404, 5205 Leesburg Pike, Falls Church, VA, 22041, US

(73) Assignee: Porng Da Enterprise Co., Ltd.

(21) Appl. No.: 10/132,219

(22) Filed: Apr. 26, 2002

(51) Int. Cl. H04B 1/38

(52) U.S. Cl. 455/573; 455/90.3; 455/575.1

(57) ABSTRACT

The present invention relates to a mobile phone charger comprising a main device and connection cord. The main device is a transformer incorporating USB receptacle. A USB plug is provided in one end of the connection cord for plugging-in the USB receptacle of the main device; and a charger plug is provided in the other end of the connection cord. The present invention allows users to charge mobile phones when the connection cord connects to the main device. Users can also charge their mobile phones through household power sources, automobile power sources, computers and other power sources simultaneously when the connection cord connects to the main device.

### BACKGROUND OF THE INVENTION

1. Field of the Invention

The present invention relates to a mobile phone charger that allows users to store power in their mobile phones, especially referring to charging mobile phones at homes, from automobiles, and via computers.

2. Description of the Prior Art

As shown by FIG. 1, conventional mobile phone charger comprises a transformer plug and a cord extending to a mobile phone holder. Users plug the transformer in the indoor receptacle and place their mobile phone in the mobile phone holder to charge mobile phone. After mobile phone is charged, users can use the mobile phone in a normal manner. The simplified model of mobile phone charger is provided with a charger plug connecting to the cord, thereby allows users to charge their mobile phones.

However, the conventional mobile phone charger is designed in such a way that the transformer incorporates the cord as a one-piece device. As a one-piece device, the conventional mobile phone charger cannot be moved around; and can be installed at homes only. Users need another charger if they charge mobile phone in automobiles. In addition, the conventional mobile phone charger lacks USB interface; and therefore cannot receive power from USB interface through the compatible plugs via computers and transform the power into the voltage required by mobile phones to the charger via DC transformation circuit.

The inventor has thoroughly studied the foregoing problems related to the conventional mobile phone charger and presents a mobile phone charger that allows users to charge their mobile phones at home, from their automobiles, and through the computers.

### SUMMARY OF THE INVENTION

The present invention relates to a mobile phone charger that allows users to charge their mobile phones through the general household power source, automobiles, computers, and computer-related power sources.

To serve the foregoing purposes, the present invention comprises a main device and connection cord. The main device is a transformer incorporating USB receptacle. A USB plug is provided in one end of the connection cord for plugging-in the USB receptacle of the main device; and a charger plug is provided in the other end of the connection cord. Therefore, users can connect the connection cord to the main device to charge mobile phone. Users can also charge mobile phone through household power sources, automobile power sources, computers or other power sources simultaneously when the connection cord connects to the main device.

The present invention will be apparent in its technical content after reading the detailed description of the preferred embodiments of the present invention in reference to the accompanying drawings, wherein:

### BRIEF DESCRIPTION OF THE DRAWINGS

FIG. 1 is a three-dimensional view showing the structure of the conventional mobile phone charger;

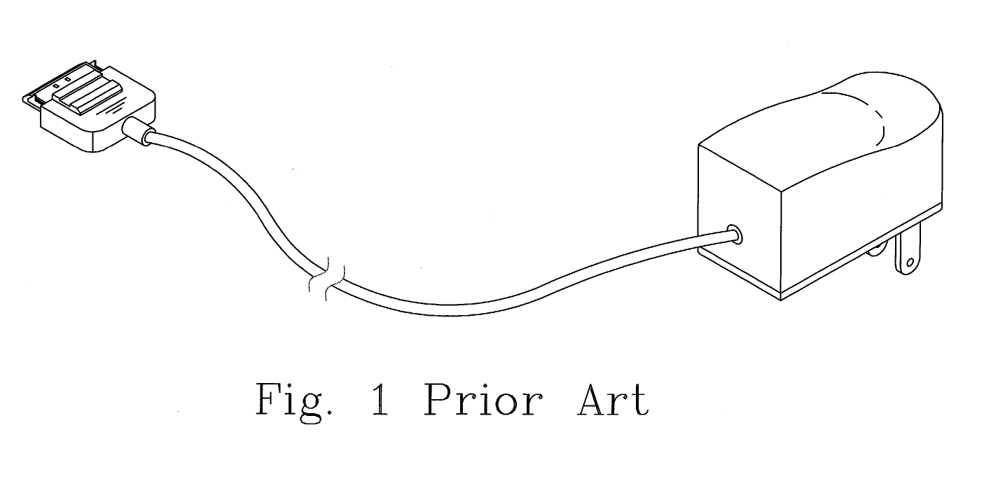

FIG. 2 is a three-dimensional view showing the connection cord of the present invention;

FIG. 3 is a schematic view showing the present invention in use;

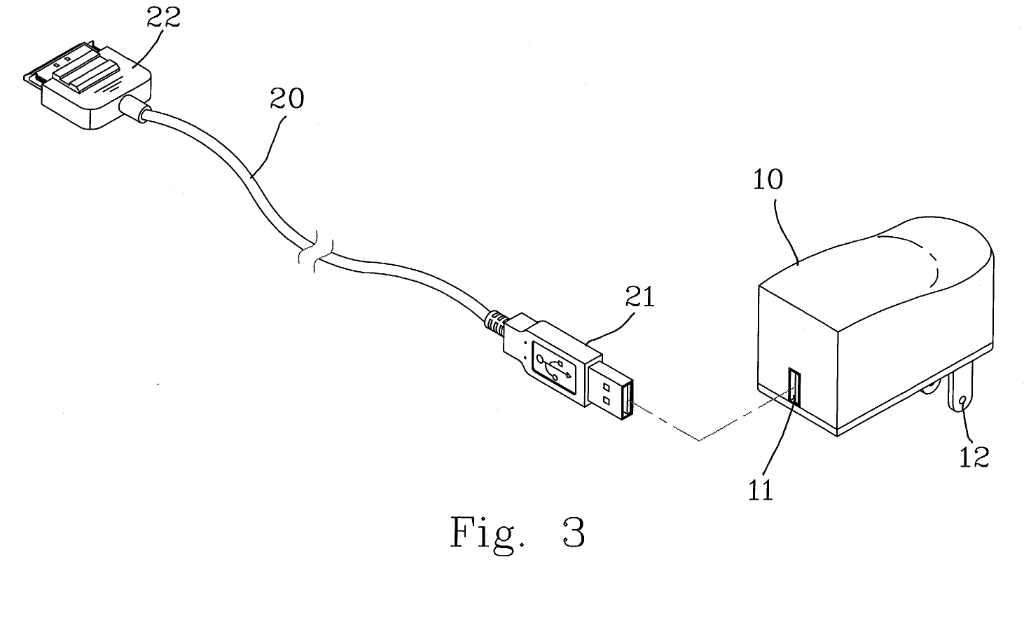

FIG. 4 is a schematic view showing the present invention charging mobile phone from automobile;

FIG. 5 is a schematic view showing the present invention connecting to a computer;

FIG. 6 is a schematic view showing the connection cord of present invention provided with cord-winding device.

### DETAILED DESCRIPTION OF THE PREFERRED EMBODIMENT

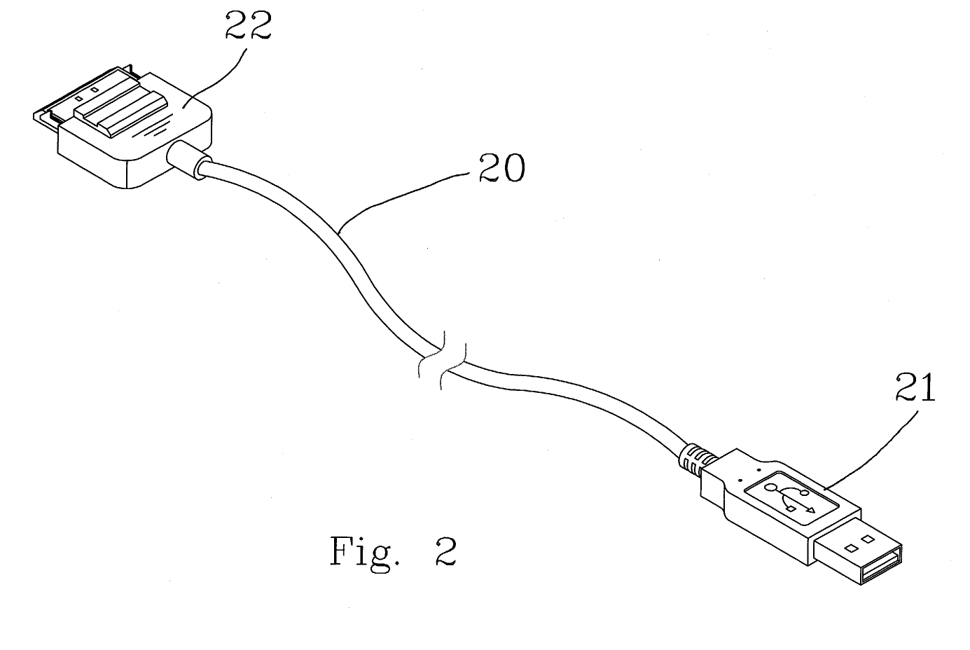

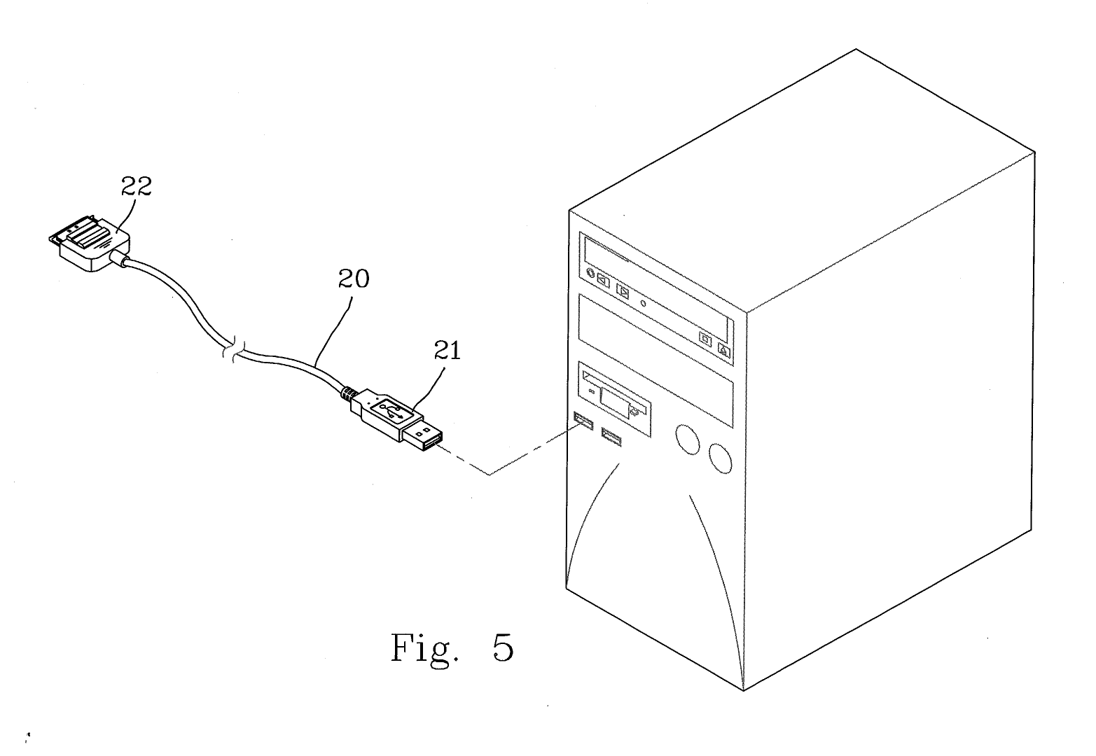

As shown by FIG. 2˜FIG. 5, the present invention comprises main device 10 and connection cord 20.

The main unit 10 is a transformer incorporating power plug 12. A USB receptacle 11 is provided in the transformer.

A USB plug 21 is provided in one end of the connection cord 20 for plugging-in the USB receptacle 11 of the main unit 10. The other end is provided with a mobile phone plug 22 compatible to all brands of mobile phones.

As shown by FIG. 2, when mobile phone runs out of power and users need to charge the battery of mobile phone, users can insert the mobile phone plug 22 of the connection cord 20 into the charger holder (not shown in the Figure) and insert USB plug 21 of connection cord 20 into USB receptacle 11 of the main device 10 in order to connect the main device 10 and connection cord 20 to power supply plug 12 and power source receptacle. The transformer and the connection cord 20 provided inside the main device 10 transmits the power to the mobile phone for storage.

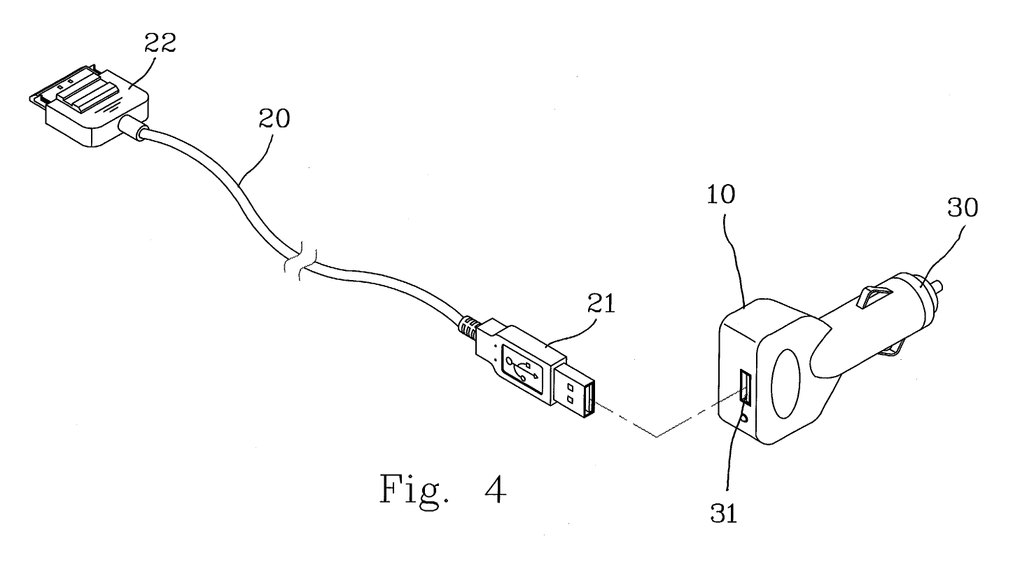

As shown by FIG. 4, if users charge mobile phone in the automobile, one end of the main device is the cigarette lighter 30 and the other end is USB receptacle 31 that allows users to charge mobile phone through the USB plug 21 of connection cord 20.

As shown by FIG. 5, users can connect the charger to computers via USB plug 21 of connection cord 20. When the connection cord 20 connects to the computers, users can charge mobile phone as they use computers.

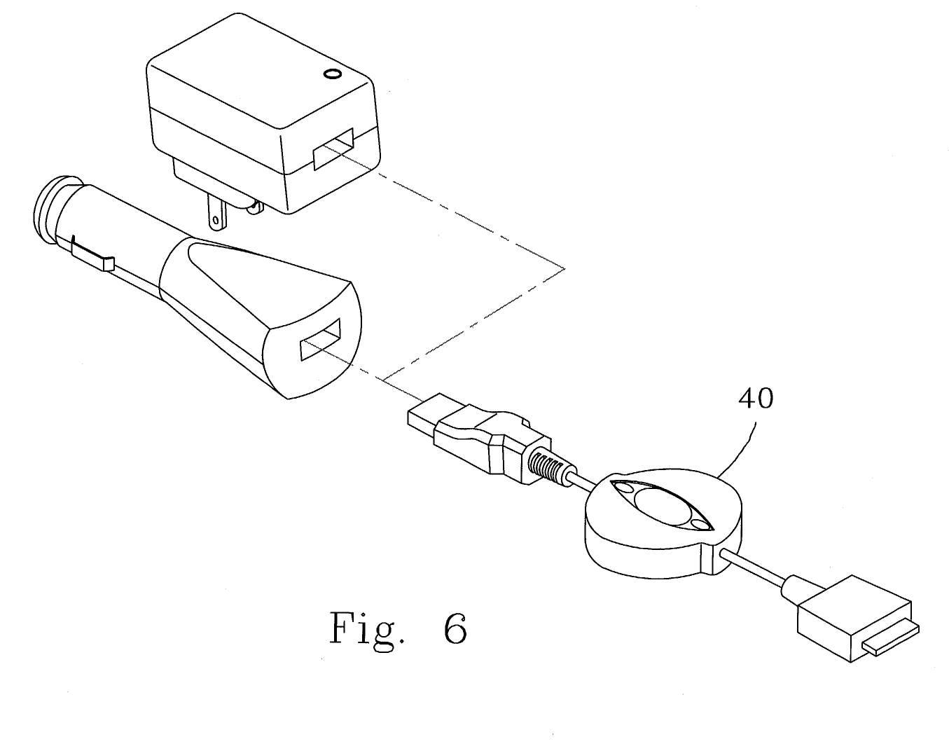

As shown by FIG. 6, a cord-winding device 40 can be provided in the connection cord 20, so users can carry the present invention easily. If the present invention is not in use, users can wind the connection cord 20 to save space and keep their charger neatly.

Following are the advantages of present invention:

1. If any component of present invention malfunctions, users can purchase a single component—main device or connection cord—for replacement; and need not to buy a brand new charger.

2. When users change mobile phone, all they have to do is to change the connection cord.

3. The present invention is compatible with general chargers and automobile cigarette lighters.

4. The foremost advantage is the compatibility to PCs; and thus users can charge their mobile phone and use computers simultaneously.

As described in foregoing statement, the present invention is designed in a concise manner and allows users to select the most appropriate main device and connection cord wherever they are. The present invention is industrially progressive and has never been released in any publications and, therefore, the inventor files application for patent.

The present invention has been described in conjunction with the preferred embodiment. To those skilled in the art, modification may be made in the invention without departing from the spirit and scope of the subject invention as set forth in the claims below.

Having thus described my invention, what the inventor claims as new and desire to be secured by Letters Patent of the United States include:

1. A mobile phone charger comprising:
a main device, which is a household transformer or automobile cigarette lighter, provided with power source plug and USB receptacle, and
a connection cord with USB plug provided in one end and mobile phone plug provided in the other end.
Thus, when the connection cord connects to the main device, users can charge mobile phone at home, from automobile, and via computers.

2. A mobile phone charger as stated in claim 1, the mobile phone plug of the main device is compatible to all brands of mobile phone plugs.

3. A mobile phone charger as stated in claim 1, a cord-winding device is provided in the connection cord that allows users to wind the cord if their charger is not in use.
